(19) United States
(12) Patent Application Publication
(10) Pub. No.: US 2016/0046416 A1
(43) Pub. Date: Feb. 18, 2016

(54) OUTDOOR ICE CHEST

(71) Applicant: Sainty International, LLC, Ventura, CA (US)

(72) Inventor: Haining Gao, Nanjing (CN)

(21) Appl. No.: 14/571,768

(22) Filed: Dec. 16, 2014

(30) Foreign Application Priority Data
Aug. 13, 2014 (CN) 201420455483.X

(51) Int. Cl. B65D 43/16; B62B 3/00; B65D 81/38; F25D 3/08; B65D 81/18

(52) U.S. Cl. CPC B65D 43/161; F25D 3/08; B65D 81/18; B65D 81/3813; B65D 43/167; B62B 3/004

(57) ABSTRACT

An outdoor ice chest includes a cover with two opposed horizontal cover plates connected to each other via a hinge shaft. A first connecting block is provided at each end of the hinge shaft. The ice chest includes second connecting blocks corresponding to the first connecting blocks and fixed on an external wall of the chest body. A vertical guide slot is provided on the second connecting blocks and a guide rib matching the guide slot is provided on the first connecting blocks. When the cover is opened to take out contents of the chest or the chest is moved, this cover does not dislodge or fall off.

### CROSS-REFERENCE TO RELATED APPLICATIONS

This application claims the benefit of the priority date of Chinese Application No. 201420455483.X, filed Aug. 13, 204, which is incorporated herein in its entirety.

### FIELD

Outdoor ice chests are described, and more specifically, household thermal insulated ice chest vessels.

### BACKGROUND

With constant development of society and economy, living standards are ever higher and ice chests are often used in daily life as vessels to store iced drinks and other items. People often use outdoor ice chests containing ice and iced drinks for picnics and outdoor parties. Present outdoor ice chests typically have a simple structure and are not easy to move. The cover of such chests is simply put on the chest body and for moving or taking out drinks, and the cover may fall easily.

### SUMMARY

A type of outdoor ice chest is disclosed the cover of which does not fall easily, so as to overcome the shortcomings of the prior art.

In one embodiment, a type of outdoor ice chest includes a cover comprising two apposed horizontal cover plates connected to each other via a hinge shaft. At each end of this hinge shaft, a first connecting block is provided. On the chest body, second connecting blocks corresponding to the first connecting blocks are provided and fixed on external wall of the chest body. A vertical guide slot is provided on the second connecting blocks and a guide rib matching the guide slot is provided on the first connecting blocks. One advantage of such a chest is that, since the chest cover is fixed on the chest body via matching between first connecting block and second connecting block, when the cover is opened to take out drink or the chest is moved, the cover will not fall easily.

In one approach, a screw is provided at each end of the hinge shaft and penetrates the first connecting block to fix it on the hinge shaft. One advantage is that, when the chest is very full and the chest body may deform slightly, screws at both ends of the hinge shaft can be tightened so that the first connecting blocks tightly clamp the chest body, correcting the deformation.

In an embodiment, at hinging position between the two cover plates, matching grooves and protruding blocks are provided and the hinge shaft penetrates these grooves and protruding blocks. Advantageously, since the matching grooves and protruding blocks are provided at the hinging position between the two cover plates, the hinge shaft penetrates these grooves and protruding blocks, making the hinge shaft subject to more even stressing.

In one approach, the chest body is a cuboid and at least three support feet are provided under the chest body, with universal wheels fixed on the support feet. With the support feet being provided, the ice chest is advantageously positioned higher relative to the support surface, facilitating a user in taking-out of the contents of the chest body (e.g., a drink). With the universal wheels being provided, the ice chest can be easily moved.

In an embodiment, chest handles are installed at two opposite side external walls of the chest body and cover handles are installed on the cover plates. These chest handles and cover handles advantageously provide for easy movement and opening of the ice chest.

In one approach, a drain hole is provided at bottom of side wall of the chest body, with a matching hole cover installed. With the drain hole available, water in the ice chest formed by melting of ice cart be directly drained, advantagesously facilitating cleaning.

In yet another approach, a threaded connection is provided as art adapter between the drain hole and hole cover. In this approach, since the hole cover is connected to the drain hole via a threaded connection, their combination is tight, effectively preventing water leakage from the drain hole.

In one embodiment, a bottle opener is installed on external wall of the chest body, advantageously facilitating the opening of bottles.

### BRIEF DESCRIPTION OF THE DRAWINGS

FIG. 1 is a perspective view of an outdoor ice chest according to one embodiment.

FIG. 2 is an enlarged fragmentary perspective view of cover plates of the outdoor ice chest of FIG. 1, showing the hinging between the cover plates.

FIG. 3 is a perspective view of the outdoor ice chest of FIG. 1, shown with one cover opened.

FIG. 4 is a perspective view of a first connecting block of the ice chest of FIG. 1.

FIG. 5 is a perspective view of a second connecting blocks of the ice chest of FIG. 1.

### DETAILED DESCRIPTION

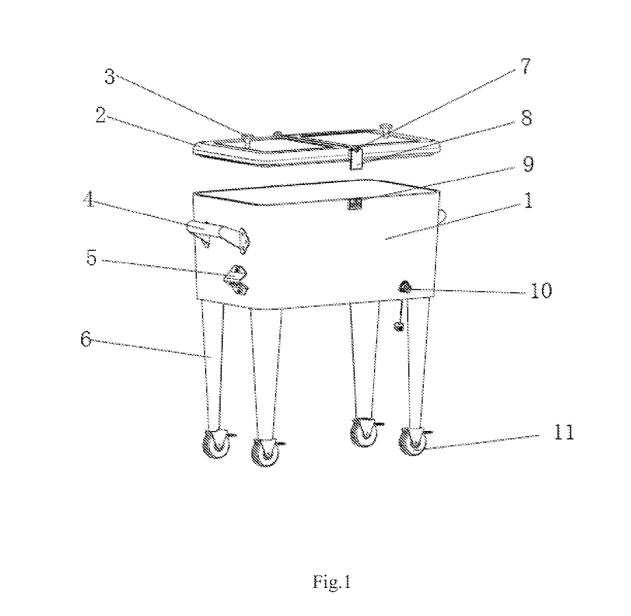

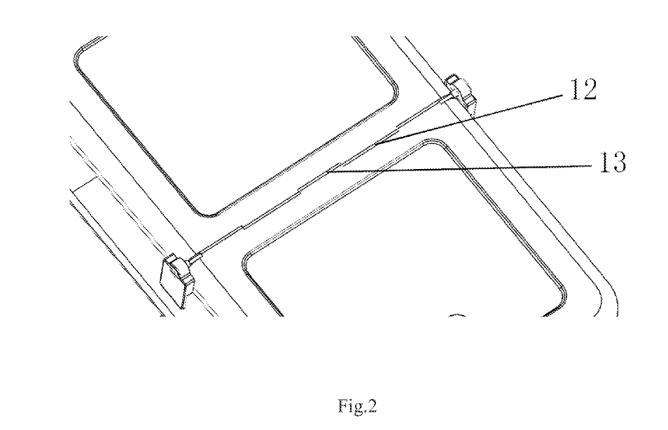

As shown in FIG. 1, the outdoor ice chest of this preferred embodiment comprises a chest body 1 and matching chest cover 2. The chest cover 2 consists of two opposed horizontal cover plates and at tipper end of these cover plates on the side of their connection. As shown in FIG. 2, a number of matching pairs of grooves 12 and protruding blocks 13 are provided, so that the two cover plates are hinged via a hinge shaft penetrating grooves 12 and protruding blocks 13, allowing even stressing of this hinge shaft owing to matching with grooves 12 and protruding blocks 13, extending the service life.

The two cover plates of the chest cover 2 can rotate around this hinge separately or at the same time. At each end of the hinge shaft, first connecting block 8 is provided and includes a guide rib 14 at the side near the chest body 1. On the chest body 1, second connecting blocks 9 corresponding to first connecting blocks 8 are provided and fixed on the external wall of the chest body 1. The second connecting blocks 9 include vertical guide slot 15 matching the guide rib 14. When the chest cover 2 is put on the chest body 1, the guide rib 14 extends into the guide slot 15 so that the chest cover 2 will not be disengaged from the chest body 1 due to left-right sliding or slight bumping during transport. To remove the chest cover 2, the chest cover 2 may be conveniently lifted so that the guide rib 14 is disengaged from the guide slot 15.

In the preferred embodiment, each end of the hinge shaft includes a socket head cap screw 7, which penetrates the first connecting block 8 and fixes the first connecting Hock 8 on the hinge shaft. In one form, when the chest body 1 is too full, the chest body 1 may deform slightly. The screws 7 at both ends of the hinge shaft can be then be tightened so that the first connecting blocks 8 tightly clamp the chest body 1, correcting the deformation.

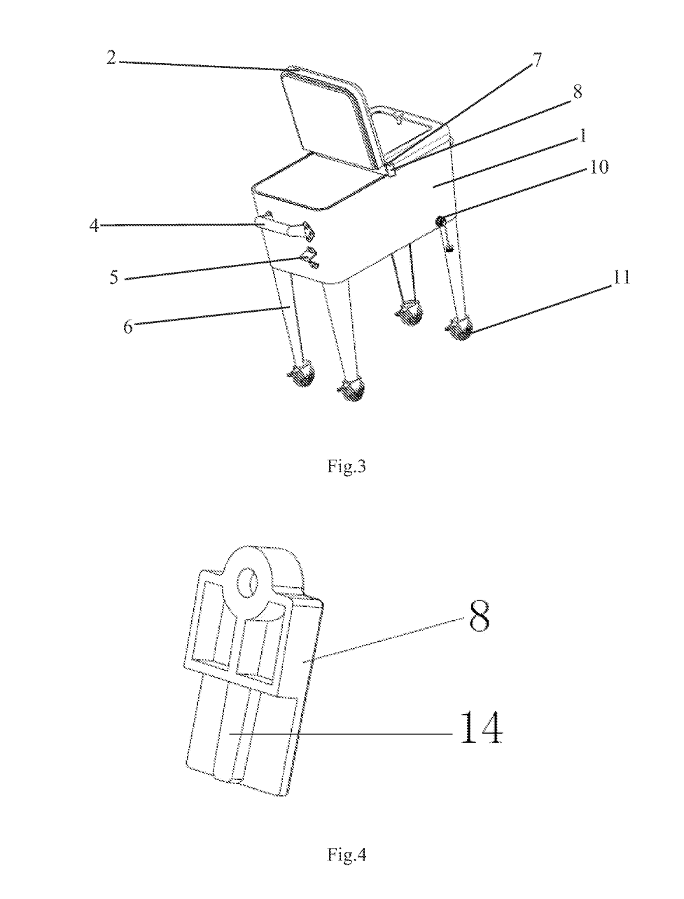

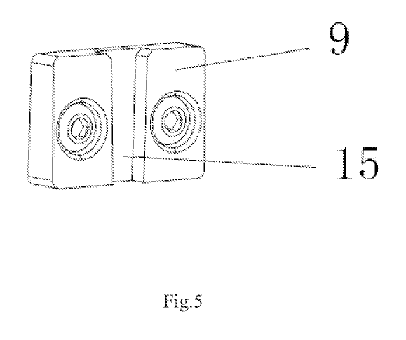

In the illustrated exemplary embodiment, the chest body 1 is a cuboid and four support feet 6 are provided under the chest body 1, with universal wheels 11 fixed on the support feet 6. The universal wheels 11 are complete with brake, so that to place the chest body 1 at a standstill position, these brakes can be engaged to prevent slipping of the chest body 1. To move the chest body 1, the brakes may be disengaged. On two opposite side walls of the chest body 1, the chest body handle 4 is installed to facilitating pushing the ice chest from both sides. In the illustrated embodiment, at the ends of the chest cover 2 away from the hinge, the chest cover handle 3 is installed as shown in FIG. 3. The internal walls of the chest body 1 and the chest cover 2 may include a thermal insulation layer to allow better thermal insulation.

At the bottom of the chest body 1, a drain hole 10 may be provided and fitted with a matching hole cover, with a threaded connection configured as an adapter between the drain hole 10 and the matching hole cover. A connection rope may be provided between the hole cover and the drain hole 10 to prevent the disengagement and possible loss of the hole cover. The water in the ice chest generated by melting of ice can be drained through drain hole 10, advantageously providing for easy drainable of the chest body 1. On external wall of chest body 1, a bottle opener 5 may be installed to facilitate opening of bottles.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. An outdoor ice chest, comprising:
a chest body and a matching chest cover; wherein said cover consists of two opposed horizontal cover plates connected to each other via a hinge shaft;
at least one first connecting block provided at each end of said hinge shaft and a at least one second connecting block corresponding to said first connecting block is provided on the said chest body, said at least one second connecting block being fixed on an external wall of said chest body;
a vertical guide slot provided on said at least one second connecting block; and
a guide rib matching said vertical guide slot provided on said at least one first connecting block.

2. The outdoor ice chest according to claim 1, further comprising a screw at each end of said hinge shaft, wherein the screw penetrates said first connecting block to fix it on the hinge shaft.

3. The outdoor ice chest according to claim 1, further comprising matching grooves and protruding blocks at a hinging position between said two cover plates, and wherein said hinge shaft extends into said matching grooves and protruding blocks.

4. The outdoor ice chest according to claim 1, wherein said chest body is a cuboid and at least three support feet are provided under said chest body, said support feet including universal wheels fixed to said support feet.

5. The outdoor ice chest according to claim 1, further comprising chest handles on the external wall of said chest body and further comprising cover handles on said cover plates.

6. The outdoor ice chest according to claim 5, further comprising a drain hole at a bottom of said chest body and further comprising a matching hole cover installed over said drain hole.

7. The outdoor ice chest according to claim 6, further comprising a threaded connection configured as an adapter between said hole cover and said drain hole.

8. The outdoor ice chest according to claim 5, further comprising a bottle opener on the external wall of said chest body.
